(19) United States
(12) Patent Application Publication
(10) Pub. No.: US 2011/0001701 A1
(43) Pub. Date: Jan. 6, 2011

(54) PROJECTION APPARATUS

(75) Inventor: Katsuya Nakano, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/865,377

(22) PCT Filed: Jan. 28, 2009
(86) PCT No.: PCT/JP2009/000316

§ 371 Date: Jul. 29, 2010

(30) Foreign Application Priority Data
Jan. 31, 2008 (JP) 2008-021070

(51) Int. Cl. G09G 5/00; G09G 5/08

(52) U.S. Cl. 345/157

(57) ABSTRACT

A projection apparatus includes a projection unit configured to project an image onto a projection screen; an image pickup unit configured to capture an image on the projection screen; a detection unit configured to detect at least one pointer image using an image signal obtained by the image pickup unit, the pointer image indicating a position on the projection screen, the detection unit generating position information regarding the position indicated by the pointer image displayed on projection screen; and an output unit configured to output the position information to the outside.

### TECHNICAL FIELD

The present invention relates to projection apparatuses.

### BACKGROUND ART

Projectors which display images by projecting the images onto projection surfaces, such as screens, are known.

A projector is used, for example, by a presenter who makes a presentation at a meeting while displaying reference images.

In this case, the presenter often indicates a certain position which corresponds to contents of the explanation on the screen with, for example, a laser pointer held by the hand.

Another method for indicating a position on a projection screen is described in, for example, Japanese Patent Laid-Open No. 2005-62486. According to this method, a laser emission unit of a laser pointer is installed in a projector and the position on the screen is indicated by displaying a pointer image on the screen in response to a remote control operation performed by a user.

Recently, some projectors have been used while they are connected to a network. More specifically, multiple projectors can be connected to a network so that the same presentation data can be displayed at distant locations and a meeting can be held at multiple locations at the same time.

### Patent Citation 1: Japanese Patent Laid-Open No. 2005-62486

### DISCLOSURE OF INVENTION

However, in the case where projectors at different locations are connected to each other and a meeting is held while the same presentation data is displayed at different locations, even if a presenter indicates a certain position on a projection screen with a pointer, the pointer cannot be displayed on projection screens of other projectors.

In this case, participants looking at the same projection screen as the projection screen on which a pointer is shown by the presenter to indicate a certain position can listen to the presentation while recognizing the position indicated by the presenter.

However, participants looking at a projection screen different from the projection screen on which the pointer is shown by the presenter to indicate the position cannot recognize the position indicated by the presenter. This makes it difficult to understand the explanation given by the presenter.

To solve the above-described problem, the present invention allows a pointer image displayed on a projection screen to be displayed also on a display screen of an external apparatus.

### BRIEF DESCRIPTION OF THE DRAWINGS

FIG. 1 is a diagram illustrating a display system structure according to a first embodiment of the present invention.

FIG. 2 is an external view of a projector according to the first embodiment.

FIG. 3 is a block diagram illustrating the structure of the projector according to the first embodiment.

FIG. 4 is a flowchart of a display-mode switching process performed by the projector according to the first embodiment.

FIG. 5 is a flowchart of a process of a normal display mode performed by the projector according to the first embodiment.

FIG. 6 is a flowchart of a process of a simultaneous display mode performed by the projector according to the first embodiment.

FIG. 7 is a flowchart of a pointer-image detection process performed by the projector according to the first embodiment.

FIG. 8 is a diagram illustrating a projection-area detection image used for detecting a projection area.

FIG. 9 is a diagram illustrating the position of a pointer image.

FIG. 10 is a flowchart of a process of transmitting position information of a pointer image performed by the projector according to the first embodiment.

FIG. 11 is a block diagram illustrating the structure of a display apparatus according to the first embodiment.

FIG. 12 is a flowchart of a process of a simultaneous display mode performed by the display apparatus according to the first embodiment.

FIG. 13 is a flowchart of a pointer-image display process performed by the display apparatus according to the first embodiment.

FIG. 14 is a diagram illustrating a display screen of the display apparatus according to the first embodiment.

FIG. 15 is a flowchart of a pointer-image detection process performed by a projector according to a second embodiment of the present invention.

FIG. 16 is a flowchart of a process of transmitting position information of pointer images performed by the projector according to the second embodiment.

FIG. 17 is a flowchart of a pointer-image display process performed by a display apparatus according to the second embodiment.

FIG. 18 is a diagram illustrating a display system structure according to another embodiment.

FIG. 19 is a diagram illustrating a display system structure according to another embodiment.

FIG. 20 is a diagram illustrating a display screen of a display apparatus according to another embodiment.

### BEST MODE FOR CARRYING OUT THE INVENTION

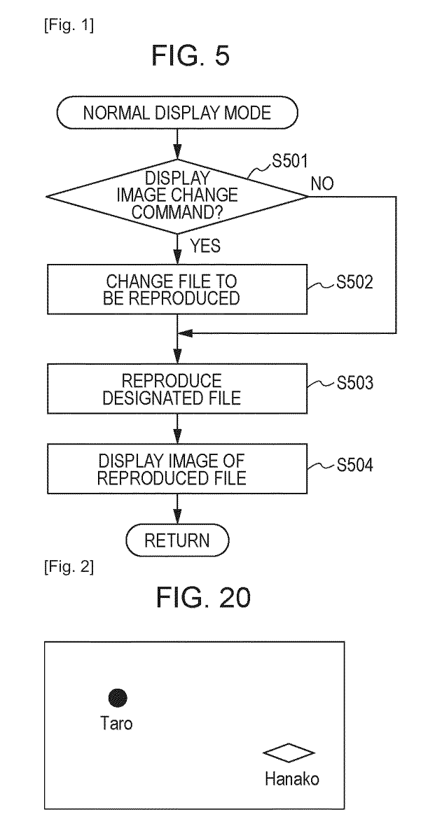

FIG. 1 is a diagram illustrating the structure of a display system 100 including a projection apparatus 101 according to a first embodiment of the present invention.

The display system 100 includes the projection apparatus (liquid crystal projector) 101, a projection screen 102 onto which an image is projected by the projector 101, and a display apparatus 103. The projector 101 and the display apparatus 103 are connected to each other with a transmission line 104. Image data, commands, etc. can be transmitted between the projector 101 and the display apparatus 103.

The projector 101 can be connected to a personal computer (PC) 105 with a connection line 106, and an image output from the PC 105 can be displayed on the projection screen 102. A user 107 can display a pointer image 109 on the projection screen 102 by operating a known laser pointer 108. Thus, an arbitrary position on the projection screen 102 can be indicated.

According to the present embodiment, a connection cable corresponding to the Ethernet (registered trademark) is used as the transmission line 104 between the projector 101 and the display apparatus 103. The projector 101 and the display apparatus 103 are connected to each other via TCP/IP, which is a common network. The connection between the projector 101 and the display apparatus 103 is not limited to the Ethernet (registered trademark) and other connection types such as USB and wireless LAN can also be used as long as commands can be transmitted between the projector 101 and the display apparatus 103.

According to the present embodiment, as described below, image data of images to be displayed is stored in a memory included in the projector 101. The image data can be transmitted to the display apparatus 103 through the transmission line 104, thereby causing the display apparatus 103 to display an image.

In this case, various commands can be transmitted from the projector 101 to the display apparatus 103 together with the data of an image to be displayed. Thus, operations including an operation of switching the display screen of the display apparatus 103 can be controlled.

FIG. 2 is an external view of the projector 101.

Referring to FIG. 2, the projector 101 includes a housing 201. A projection unit 202 emits projection light and causes the projection light to be incident on a projection surface, thereby displaying an image on the projection screen. An image pickup unit 203 captures the image displayed on the projection screen by the projection unit 202. According to the present embodiment, the image obtained by the image pickup unit 203 is used to control a focusing operation performed by the projection unit 202 and to detect the position of a pointer image displayed on the projection screen.

An operation unit 204 includes various switches which can be operated by the user to control the operation of the projector 101. A display unit 205 displays various information. The user can operate the projector 101 while viewing the information displayed on the display unit 205.

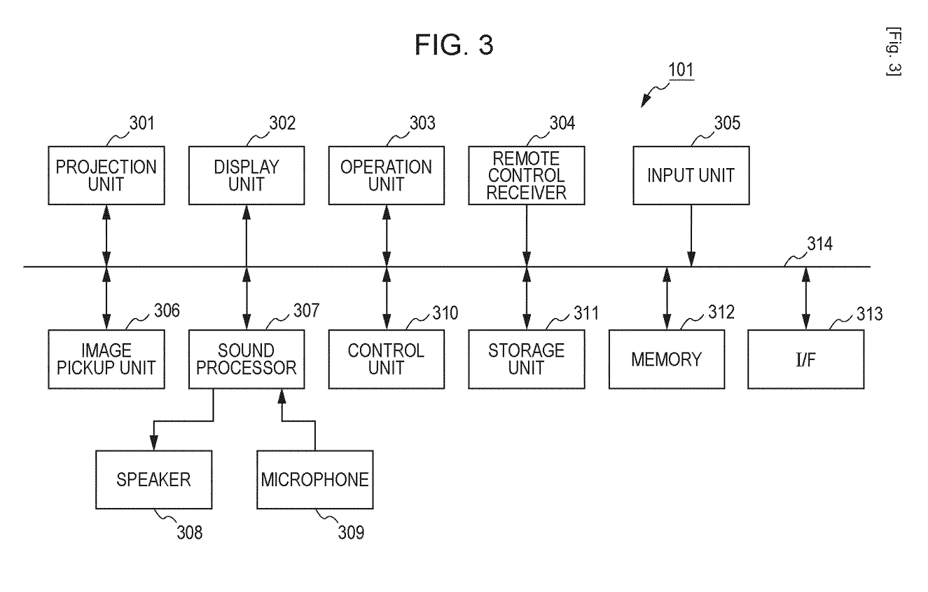

FIG. 3 is a block diagram illustrating the functional structure of the projector 101.

Referring to FIG. 3, a projection unit 301 includes a projection lens, a liquid crystal panel, and a light unit which serves as a light source. The projection unit 301 serves to project an image in response to a command from a control unit 310. A display unit 302 displays various information. An operation unit 303 includes various switches and operation keys. The display unit 302 corresponds to the display unit 205 shown in FIG. 2, and the operation unit 303 corresponds to the operation unit 204 shown in FIG. 2.

A remote control receiver 304 receives a command from a remote control device (not shown) and transmits the command to the control unit 310. An input unit 305 receives image data from an external device, such as the PC 105 shown in FIG. 1, and stores the received image data in a memory 312. An image pickup unit 306 captures the image displayed by the projection unit 301 and outputs an image signal. A sound processor 307 receives a sound signal from a microphone 309, converts the signal into a mode suitable for transmission through an external interface (I/F) 313, and outputs the converted signal. In addition, the sound processor 307 also processes the received sound data or sound data read from a storage unit 311, and outputs sound through a speaker 308.

The control unit 310 includes a microcomputer, a register, etc. and controls the operation of each component of the projector 101. The storage unit 311 stores data of an image to be displayed. The storage unit 311 includes a nonvolatile storage medium, such as a hard disk or a flash memory. A memory 312 stores the data of the image to be displayed by the projection unit 301. The external interface (I/F) 313 is connected to an external device, such as the display apparatus 103, through the transmission line 104 shown in FIG. 1. The I/F 313 is used to transmit the image data stored in the storage unit 311 and to transmit and receive various commands A data bus 314 is used for transmitting data and commands between the blocks shown in FIG. 3.

The projector 101 according to the present embodiment has a simultaneous display mode in addition to a normal display mode in which the image corresponding to the image data stored in the storage unit 311 is displayed by being projected by the projection unit 301. In the simultaneous display mode, the image data stored in the storage unit 311 is transmitted to the external display apparatus 103 through the I/F 313, so that the same image as the image displayed by the projection unit 301 can be displayed by the display apparatus 103.

The user can select one of the above-mentioned two modes by operating a remote control unit (not shown) or the operation unit 303.

The projector 101 has an autofocus function for automatically bringing the image displayed by the projection unit 301 into focus using the image signal obtained by the image pickup unit 306. For example, when the power is turned on, an image corresponding to predetermined image data stored in the storage unit 311 is projected by the projection unit 301, and the projected image is captured by the image pickup unit 306. The focusing operation is performed by controlling lenses included in the projection unit 301 using the image signal of the captured image.

The normal display mode and the simultaneous display mode of the projector 101 will now be described.

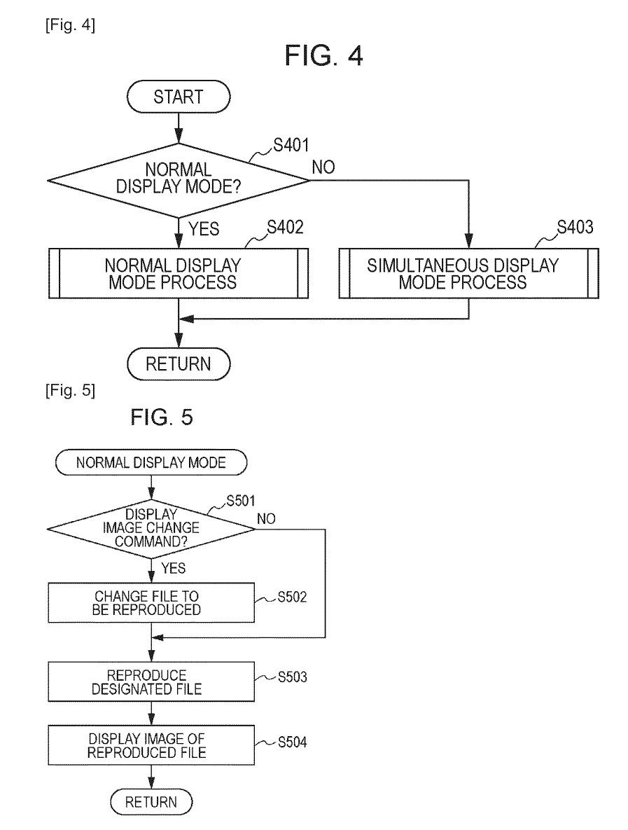

FIG. 4 is a flowchart illustrating the display operation performed by the projector 101. Here, all of the various operations described with reference to the flowcharts shown in FIGS. 4 to 7 and 10 are performed by controlling the components of the projector 101 with the control unit 310.

The process shown in FIG. 4 is started when the power of the projector 101 is turned on or when a command for switching the display mode is issued.

First, in step S401, it is determined whether or not a currently set display mode is the normal display mode. If the currently set display mode is the normal display mode, a process of the normal display mode is executed in step S402. If the currently set display mode is the simultaneous display mode, a process of the simultaneous display mode is executed in step S403.

FIG. 5 is a flowchart of the process of the normal display mode. The process shown in FIG. 5 is repeated at a predetermined timing during the operation of the normal display mode.

First, in step S501, it is determined whether or not a command for changing the displayed image is issued by the operation unit 303. If a command for changing the displayed image is issued, a file corresponding to an image to be displayed is changed to a file designated by the command in step S502. Then, the designated file stored in the storage unit 311 is reproduced in step S503, and an image corresponding to the reproduced file is projected by the projection unit 301 in step S504.

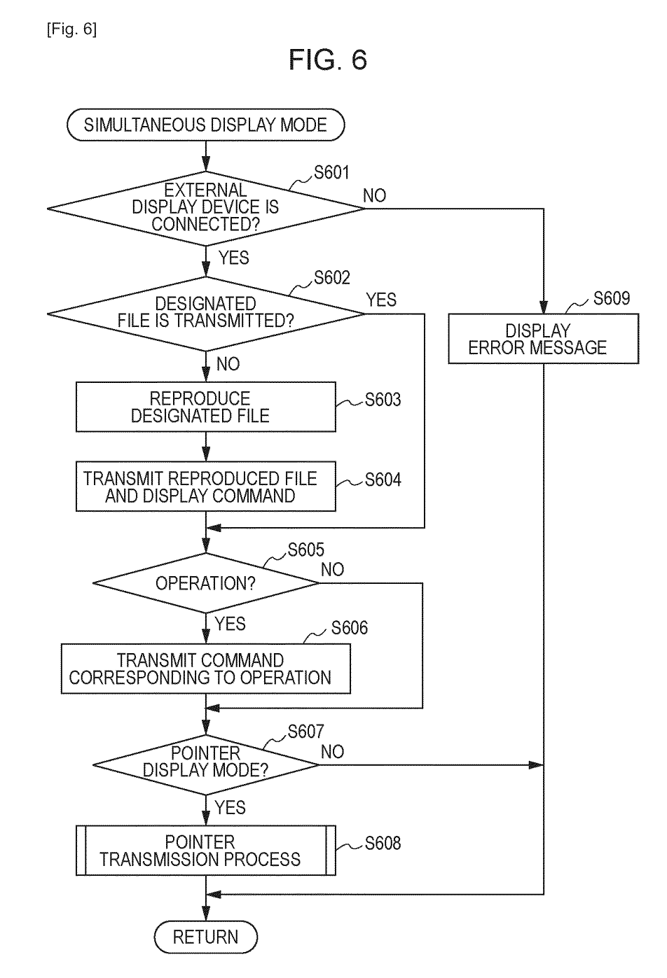

FIG. 6 is a flowchart of the process of the simultaneous display mode. The process shown in FIG. 6 is repeated at a predetermined timing during the operation of the simultaneous display mode.

First, it is determined whether or not the I/F 313 is connected to the display apparatus 103 through the transmission line 104 in step S601. The display apparatus 103 can be detected using, for example, a normal IP address set by the user. Alternatively, the display apparatus 103 can be identified using a MAC address or an ID specific to the device.

In the case where the display apparatus 103 is not connected, an error message indicating that the display apparatus 103 is absent is displayed on the display unit 302 in step S609. At this time, the projection unit 301 can be controlled so as to display the error message on the projection screen, or a warning sound can be emitted from the speaker 308.

In the case where the display apparatus 103 is connected, it is determined whether or not the designated image file is already transmitted to the display apparatus 103 in step S602. More specifically, the projector 101 and the display apparatus 103 have common application programs, and each of the application programs manages display files. In this manner, it is checked whether or not the file is present.

If the file is not yet transmitted, the designated image file is read from the storage unit 311 and is transmitted to the display apparatus 103 through the I/F 313 together with a display command for causing the display apparatus 103 to display the image of the image file in steps S603 and S604. Thus, even when the image displayed by the projector 101 is changed, the same image can be displayed by the external display apparatus 103.

Next, in step S605, it is determined whether or not an operation which relates to the displayed image, such as an operation for magnifying or reducing the display screen, has been performed by the user. If an operation has been performed, a command corresponding to the operation is transmitted to the display apparatus 103 through the I/F 313 and the display operation is controlled accordingly in step S606.

Next, it is determined whether or not a pointer display mode is set in step S607. The user can set the pointer display mode by operating a remote control unit (not shown) or the operation unit 303. In the pointer display mode, the projector 101 detects a pointer image displayed on the projection screen to obtain position information thereof and transmits the position information to the display apparatus 103 so that the pointer image can be displayed by the display apparatus 103.

In the case where the pointer display mode is set, a pointer-image transmission process is executed in step S608. In the case where the pointer display mode is not set, the process is terminated.

The pointer-image detection process will now be described.

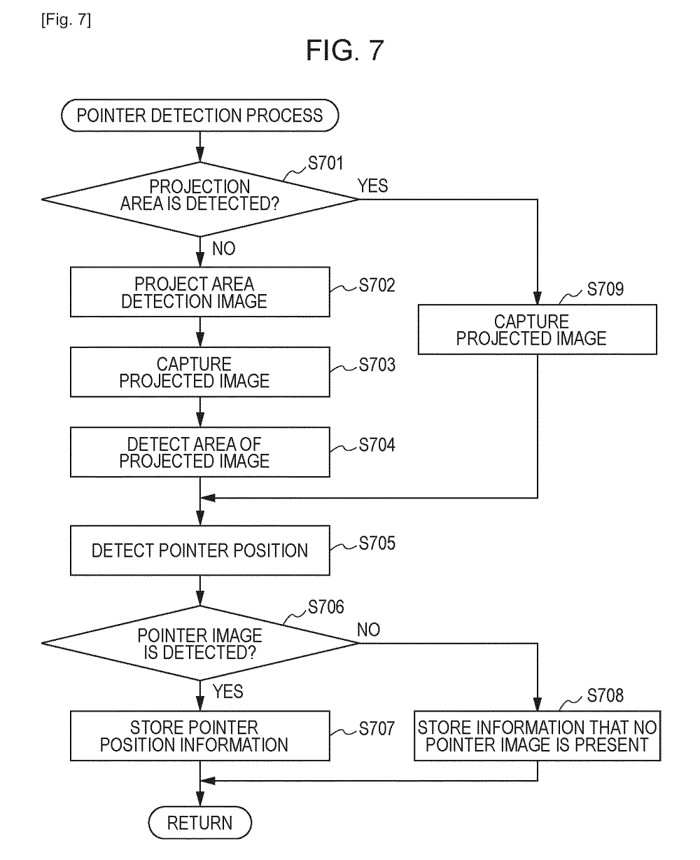

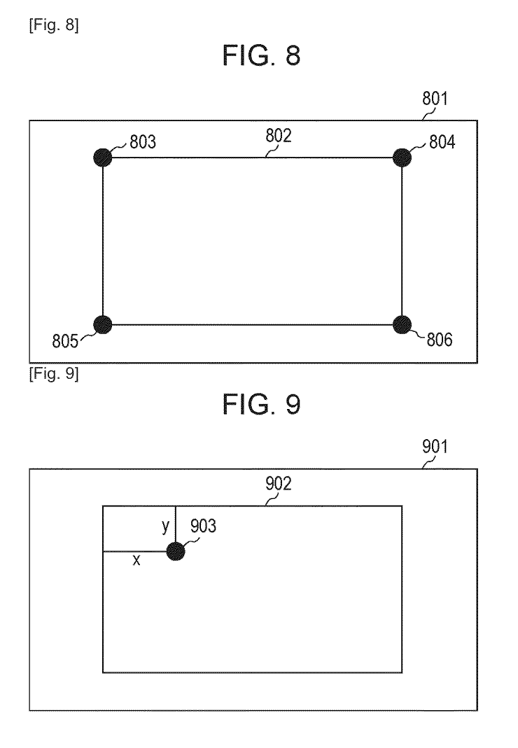

FIG. 7 is a flowchart of the pointer-image detection process for detecting the pointer image on the projection screen. According to the present embodiment, while the pointer display mode is set, the process shown in FIG. 7 is repeated at a predetermined timing to detect the position of the pointer image on the projection screen and store the detected position in the storage unit 311.

First, in step S701, it is determined whether or not a projection area of the projection unit 301 is already detected. In the case where the projection area is not yet detected, as shown in FIG. 8, projection-area detection images are projected and superimposed on the projected image in step S702. More specifically, data of images having a predetermined shape is read from the storage unit 311 and is combined with the data of an image to be projected at four corners thereof in the memory 312. Then, the thus-obtained image is projected onto the projection screen by the projection unit 301.

In the present embodiment, the projection-area detection process is performed when the pointer display mode is set or when the power is turned on.

Referring to FIG. 8, an image 802 is projected onto a projection screen 801, and detection images 803 to 806 are superimposed on the projection image 802 at four corners thereof.

Next, the image displayed on the projection screen including the projection-area detection images is captured by the image pickup unit 306 and the data of the captured image is stored in the storage unit 311 in step S703. The control unit 310 determines the positions of the detection images 803 to 806 on the basis of the data of the captured image. Then, in step S704, the area of the displayed image 802 is determined on the basis of the positions of the detection images 803 to 806.

If it is determined that the area of the displayed image is already detected in step S701, the image pickup unit 306 captures the image on the projection screen and outputs an image signal in step S705.

In step S705, the presence or absence of the pointer image displayed on the projection screen by the user and the position of the pointer image are detected on the basis of the area of the projected image determined in step S704. According to the present embodiment, information regarding the color and brightness of the pointer image formed by the laser pointer 108 is stored in the storage unit 311 in advance, and the pointer image is detected on the basis of the stored information.

In step S706, it is determined whether or not the pointer image is detected. If the pointer image is detected, position information which shows the relative position of the pointer image with respect to the data of the image being displayed is stored in the storage unit 311 in step S707. If the pointer image is not detected, information indicating that no pointer image is present is stored in the storage unit 311 in step S708.

Thus, the pointer-image detection process is repeated and the latest position information of the pointer image or the information indicating that no pointer image is present is stored in the storage unit 311.

FIG. 9 is a diagram illustrating the position of the pointer image.

Referring to FIG. 9, an image 902 is displayed on a projection screen 901. The position of a pointer image 903 relative to the displayed image 902 is determined For example, a horizontal distance x and a vertical distance y from the origin 0, 0 at the upper left corner are determined The position of the pointer image in the captured image is converted into position information for the image data reproduced by the storage unit 311, and the thus obtained position information is stored in the storage unit 311.

Next, the pointer-image transmission process performed in step S608 in FIG. 6 will be described.

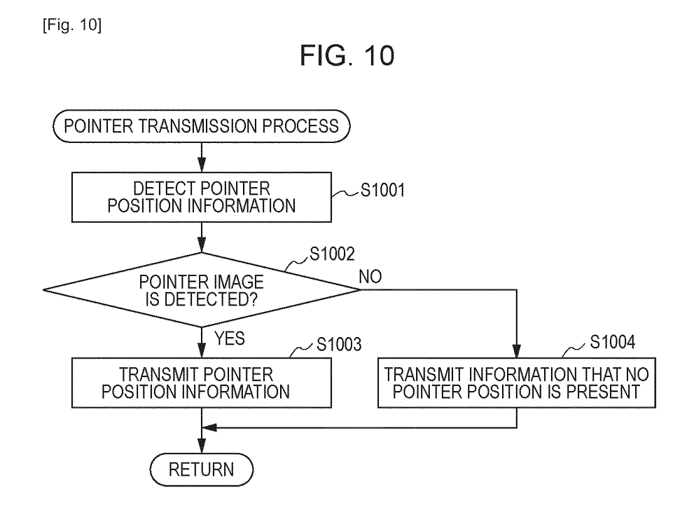

FIG. 10 is a flowchart of the pointer-image transmission process.

First, the position information of the pointer image stored in the storage unit 311 in the process described with reference to FIG. 7 is detected in step S1001. Then, in step S1002, it is determined whether or not the pointer image is detected.

If the position information of the pointer image is stored in the storage unit 311, the position information stored in the storage unit 311 is reproduced and is transmitted to the display apparatus 103 through the I/F 313 in step S1003. If the information indicating that no pointer image is present is stored in the storage unit 311, the information indicating that no pointer image is present is transmitted to the display apparatus 103 through the I/F 313 in step S1004.

Thus, when the projector 101 detects the pointer image on the projection screen, the position information of the pointer image is transmitted to the external display apparatus in accordance with the result of the detection. Therefore, when a user indicates a certain position on the projection screen using the laser pointer 108, the position information of the pointer image is synchronously transmitted to the external device.

Next, the display apparatus 103 which receives the image data, commands, and the position information of the pointer image from the projector 101 and displays an image accordingly will be described.

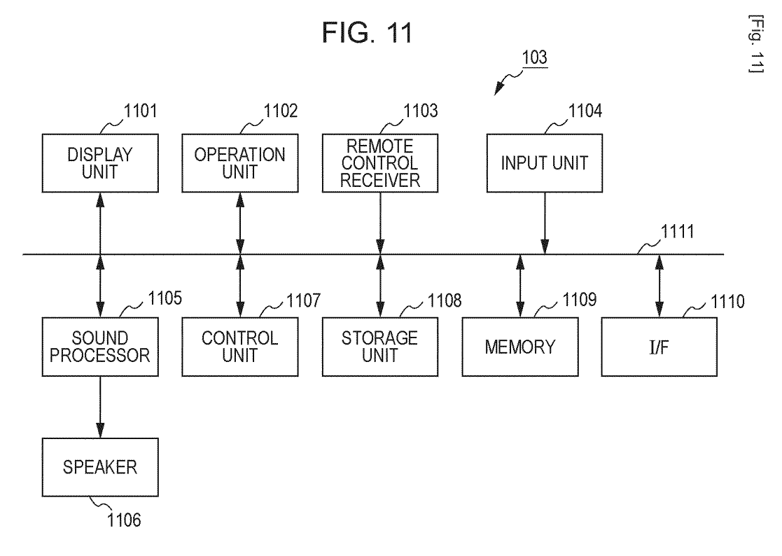

FIG. 11 is a block diagram illustrating the functional structure of the display apparatus 103.

Referring to FIG. 11, a display unit 1101 includes a liquid crystal panel and a driver. The display unit 1101 displays an image in response to a command from a control unit 1107. An operation unit 1102 includes various switches. A remote control receiver 1103 receives a command from a remote control device (not shown) and transmits the command to the control unit 1107. An input unit 1104 receives image data from an external device, such as a PC, and stores the received data in a memory 1109. A sound processor 1105 processes transmitted sound data or sound data read from a storage unit 1108, and outputs sound through a speaker 1106.

The control unit 1107 includes a microcomputer and a register and controls the operation of each component of the display apparatus 103. A storage unit 1108 stores data including the image data and the position information of the pointer image, which are received through an external interface (I/F) 1110. The storage unit 1108 includes a hard disk, a flash memory, or the like. The memory 1109 stores image data for causing the display unit 1101 to display images. The external interface (I/F) 1110 is connected to an external device, such as the projector 101, through the transmission line 104 shown in FIG. 1. The I/F 1110 is used to transmit and receive various data to and from the projector 101. A data bus 1111 is used for transmitting data and commands between the blocks of the display apparatus 103.

The display apparatus 103 according to the present embodiment has a simultaneous display mode in addition to a normal display mode in which an image corresponding to the image data stored in the storage unit 1108 or the image data input through the input unit 1104 is displayed. In the simultaneous display mode, an image corresponding to the image data received through the I/F 1110 is displayed in accordance with the received command

The user can select one of the above-mentioned two modes by operating a remote control unit (not shown) or the operation unit 1102.

In the normal display mode, the control unit 1107 controls the display unit 1101 on the basis of the image data read from the storage unit 1108 or the image data input through the input unit 1104 in response to the command from the remote control receiver 1103, and thereby displays an image.

Next, the simultaneous display mode will be described.

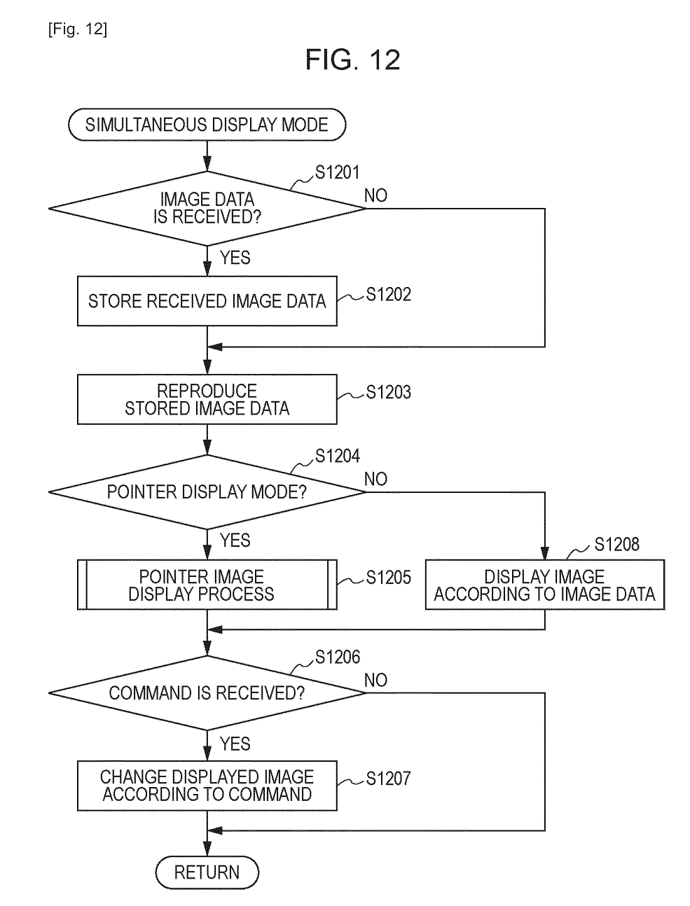

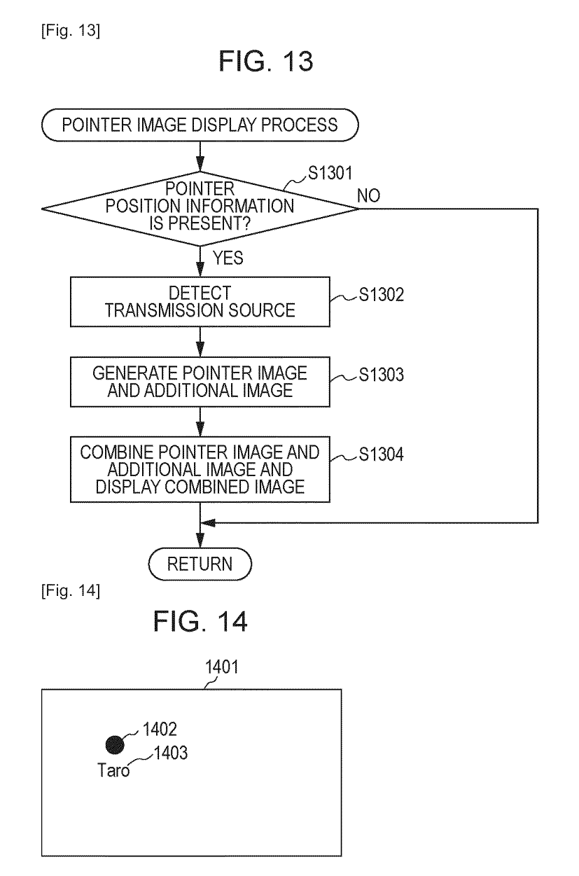

FIG. 12 is a flowchart of the operation of the simultaneous display mode. The processes shown in FIGS. 12 and 13 are performed by controlling the components of the display apparatus 103 with the control unit 1107. The process shown in FIG. 12 is repeated at a predetermined timing during the operation of the simultaneous display mode.

First, in step S1201, it is determined whether or not the image data is received by the I/F 1110. If the image data is received, the received image data is stored in the storage unit 1108 in step S1202. Then, in step S1203, the image data stored in the storage unit 1108 is reproduced in accordance with a display command received together with the image data. If the image data is not received, the image data which is currently being displayed and which is stored in the storage unit 1108 is reproduced.

Then, in step S1204, it is determined whether or not the pointer display mode is set. The user can set the pointer display mode by operating a remote control unit (not shown) or the operation unit 1102. In the pointer display mode, a pointer image is displayed on the display screen of the display unit 1101 on the basis of the position information received from the projector 101.

In the case where the pointer display mode is set, a pointer-image display process is executed in step S1205. If the pointer display mode is not set, an image is displayed in accordance with the reproduced image data in step S1208.

In step S1206, it is determined whether or not a command which relates to the displayed image is received through the I/F 1110. If a command is received, the displayed image is changed in accordance with the received command in step S1207. If no command is received, the process is terminated.

As described above, when the I/F 1110 receives the position information of the pointer image from the projector 101, the received information is stored in the storage unit 1108 as the latest pointer position information or the information indicating that no pointer image is present.

Next, the pointer-image display process performed in step S1205 will be described.

FIG. 13 is a flowchart of the pointer-image display process.

First, it is determined whether or not the position information of the pointer image received from the projector 101 is stored in the storage unit 1108 in step S1301. If the position information of the pointer image is not stored, or if the information indicating that no pointer image is present is stored, the process is terminated.

If the position information of the pointer image is stored, the information is read from the storage unit 1108 and information indicating the transmission source is detected in step S1302. More specifically, the transmission source is determined using an identifier, such as an IP address or a MAC address, of the transmission source. Then, an additional image which shows the transmission source is generated on the basis of the information indicating the transmission source. In addition, predetermined pointer image data for indicating a position on the display screen is generated in step S1302. In the present embodiment, data of an image having a predetermined shape and color is prepared in advance and stored in the storage unit 1108 as pointer image data.

Then, in step S1304, the pointer image and the additional image are superimposed on the displayed image at a position corresponding to the display position specified by the pointer position information on the basis of the position information of the pointer image.

FIG. 14 is a diagram illustrating the pointer image shown on the display unit 1101 of the display apparatus 103.

Referring to FIG. 14, a pointer image 1402 and additional information 1403 indicating the transmission source are shown on a display screen 1401.

As described above, according to the present embodiment, an image of a laser pointer displayed on the projection screen of the projector is detected. The position of the pointer image is detected on the basis of the detection result, and the position information of the pointer image is transmitted to the external display apparatus. When a user indicates a certain position on the projection screen with a laser pointer, the corresponding position information is synchronously transmitted to the external device.

Then, the display apparatus superimposes a pointer image on the display screen thereof on the basis of the received position information.

A switch command is transmitted to the display apparatus in response to a command for switching the display screen of the projector. Accordingly, the display apparatus switches the display screen thereof in accordance with the received switch command

Therefore, even when the projector and the display apparatus are at different locations, when the presenter indicates a position on the projection screen with a laser pointer, the indicated position can be displayed on the display screen of the display apparatus.

Therefore, participants looking at a display screen which is different from the projection screen on which the pointer is shown by the presenter to indicate a certain position can recognize the position indicated by the presenter. This makes it easier to understand the explanation made by the presenter.

In addition, the user can set whether or not to transmit the position information of the pointer image. Therefore, if the user wishes to discuss only with participants looking at the projection screen of the projector 101, the settings can be made such that the pointer image is not displayed on the screen of the external display apparatus.

According to the present embodiment, the user sets the pointer display mode by operating a remote control unit or an operation unit. However, the pointer display mode may also be set by other means. For example, the user can cause the laser pointer to blink on and off at a predetermined timing, and the projector can set the pointer display mode in accordance with the blinking timing of the pointer image.

In addition, according to the present embodiment, the projection-area detection images shown in FIG. 8 are used to detect the area of the projection screen provided by the projection unit.

However, the area of the projected image can be determined without using the detection images by comparing the data of the captured image with the data of the projected image. Alternatively, the area of the projected image can also be calculated from the distance to the projection screen determined by the auto-focusing function according to the present embodiment and the magnification of the projection screen.

A second embodiment of the present invention will now be described.

In the first embodiment, it is assumed that only one pointer image is displayed on the projection screen of the projector.

If two or more pointer images are displayed, the display position is detected for each of the pointer images. Then, the position information of each pointer image is transmitted to the display apparatus together with the information indicating that multiple pointer images are displayed on the same screen.

If the pointer images displayed on the projection screen of the projector have the same color and shape, the pointer images cannot be distinguished from each other.

However, if the pointer images can be distinguished from each other, one or more pointer images can be selected from the displayed pointer images and the information of the selected pointer images can be transmitted to the external display apparatus.

A case in which the information of one or more pointer images selected from the displayed pointer images is transmitted will be described as the second embodiment. The basic system structure and the operation according to the present embodiment are similar to those of the above-described first embodiment.

According to the present embodiment, a plurality of laser pointers 108 project pointer images on the projection screen of the projector 101. The pointer images formed by the laser pointers 108 have different colors or shapes. The color and shape of each of the pointer images formed by the laser pointers 108 are stored in the storage unit 311 of the projector 101 in advance.

Therefore, the positions of the pointer images displayed on the projection screen can be detected such that the pointer images are distinguished from each other.

According to the present embodiment, the position information of all of the pointer images displayed on the projection screen can be transmitted. In addition, the position information of one of more of the pointer images displayed on the projection screen can be selectively transmitted.

More specifically, the user issues a command for selecting pointer images by operating a remote control unit or the operation unit 303. The control unit 310 reads the information of the laser pointers 108 stored in the storage unit 311 and causes the projection unit 301 to display the information of the laser pointers 108.

From these laser pointers 108, the user selects one or more laser pointers 108 whose position information is to be transmitted.

A process performed in the case where only the position information of the pointer images of the selected laser pointers 108 is transmitted to the external display apparatus will be described.

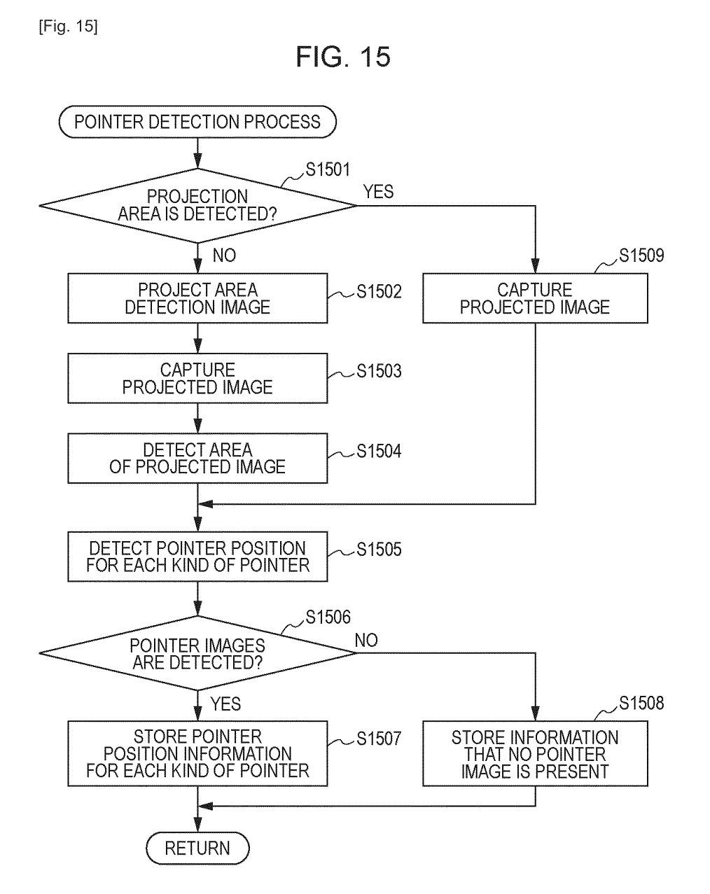

FIG. 15 is a flowchart of the pointer-image detection process for detecting the pointer images on the projection screen. Also in this embodiment, while the pointer display mode is set, the process shown in FIG. 15 is repeated at a predetermined timing to detect the positions of the pointer images on the projection screen and store the detected positions in the storage unit 311.

First, in step S1501, it is determined whether or not a projection area of the projection unit 301 is already detected. In the case where the projection area is not yet detected, as shown in FIG. 8, the projection-area detection images are projected and superimposed on the projected image in step S1502.

Next, the image displayed on the projection screen including the projection-area detection images is captured by the image pickup unit 306 and the captured image data is stored in the storage unit 311 in step S1503. Then, the area of the projected image is determined on the basis of the data of the captured image in step S1504.

If it is determined that the area of the displayed image is already detected in step S1501, the image pickup unit 306 captures the image on the projection screen and outputs image data in step S1505.

In addition, in step S1505, the presence or absence of pointer images displayed on the projection screen by the user and the position of each pointer image are detected on the basis of the area of the projected image determined in step S1504.

In step S1506, it is determined whether or not the pointer images are detected. If the pointer images are detected, position information which shows the relative positions of the pointer images in the displayed image is stored in the storage unit 311 for each kind of pointer image in step S1507. If no pointer image is detected, information indicating that no pointer image is present is stored in the storage unit 311 in step S1508.

Next, the pointer-image transmission process will be described.

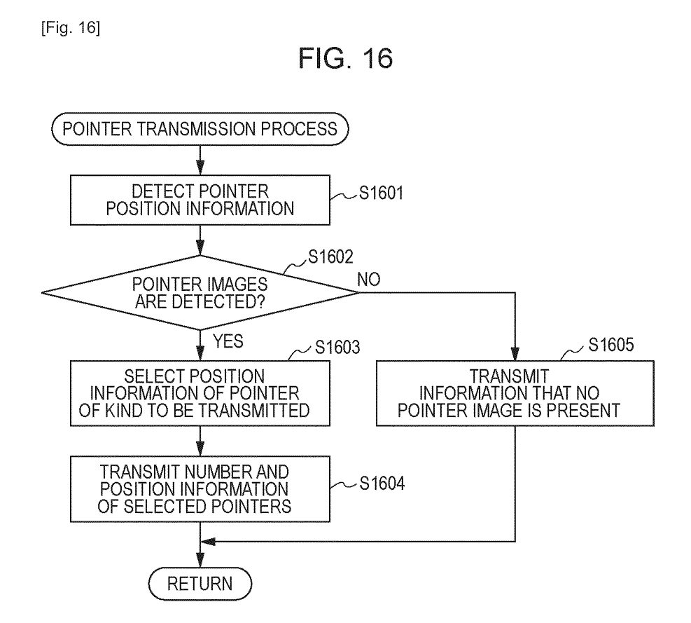

FIG. 16 is a flowchart of the pointer-image transmission process. The process shown in FIG. 16 is performed in step S608 in FIG. 6.

First, the position information of pointer images stored in the storage unit 311 in the process described with reference to FIG. 15 is detected in step S1601. Then, in step S1602, it is determined whether or not pointer images are detected.

In the case where the position information of pointer images is stored in the storage unit 311, the kind of pointer images whose position information is to be transmitted is selected and the corresponding position information that is stored in the storage unit 311 is reproduced in step S1603. Then, the number of selected pointer images, identification information for identifying the kind of each pointer image, and the position information of each pointer image are transmitted to the display apparatus 103 through the I/F 313 in step S1604. If the information indicating that no pointer image is present is stored in the storage unit 311, the information indicating that no pointer image is present is transmitted to the display apparatus 103 through the I/F 313 in step S1605.

When the position information of pointer images displayed by a plurality of laser pointers is transmitted to the display apparatus 103 as described above, the display apparatus 103 displays each pointer image on the displayed image.

Next, the pointer-image display process performed by the display apparatus 103 will be described.

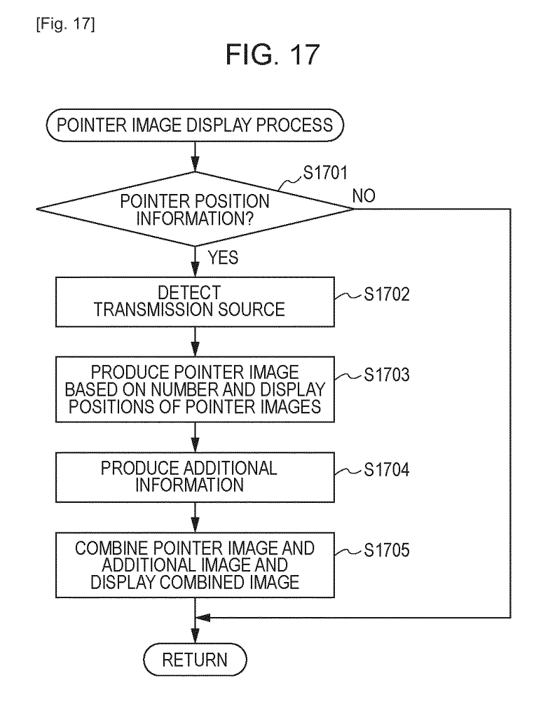

FIG. 17 is a flowchart of the pointer-image display process. The process shown in FIG. 17 is performed in step S1205 in FIG. 12.

First, it is determined whether or not the position information of the pointer images received from the projector 101 is stored in the storage unit 1108 in step S1701. If the position information of the pointer images is not stored, or if the information indicating that no pointer image is present is stored, the process is terminated.

If the position information of the pointer images is stored, the information is read from the storage unit 1108 and information regarding the transmission source is detected in step S1702. Then, pointer images having different shapes and colors are generated for each kind of pointer images on the basis of the information regarding the number and kinds of the pointer images in step S1703. In the present embodiment, data of images with different shapes and colors is prepared in advance and stored in the storage unit 1108 as data of pointer images. Then, in step S1704, additional images which show the transmission source is generated on the basis of the information regarding the transmission source.

Then, in step S1705, the pointer images and the corresponding additional images are superimposed on the displayed image at positions corresponding to the display positions specified by the pointer position information on the basis of the position information of each pointer image.

Thus, according to the present embodiment, the display positions of a plurality of kinds of pointer images displayed on the projection screen are detected for each kind of pointer images and are transmitted to the external display apparatus.

The display apparatus generates pointer images having different shapes for each kind of pointer images on the basis of the received position information of the pointer images, and displays the generated pointer images on the display screen.

Therefore, even when the projector and the display apparatus are at different locations, if the presenter indicates a plurality of positions on the projection screen with a plurality of kinds of laser pointers, the corresponding positions can be displayed on the display screen of the external display apparatus.

According to the systems of the first and second embodiments, the projector 101 and the display apparatus 103 are connected to each other with a transmission line (network) 104.

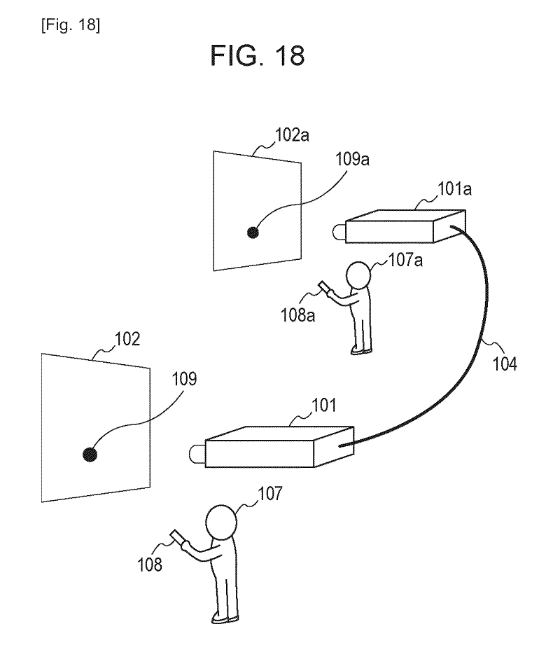

However, as shown in FIG. 18, two projectors may also be connected to each other with a network.

In FIG. 18, a projector 101a having the same structure and function as those of the projector 101 is provided. In addition, in FIG. 18, similar to the display apparatus 103 shown in FIG. 1, each of the projectors 101 and 101a have a function of generating a pointer image to be displayed on the basis of the received position information of the pointer image and superimposing the generated pointer image on the projected image. A pointer image 109a is displayed on a projection screen 102a of the projector 101a by a laser pointer 108a held by a user 107a.

The projectors 101 and 101a detect the positions of the pointer images 109 and 109a shown on the projection screens 102 and 102a, respectively, and transmit the detected positions to the projectors 101a and 101, respectively.

The projector 101 generates a pointer image on the basis of the position information transmitted from the projector 101a, and the generated pointer image is superimposed on the image that is being projected. The projector 101a generates a pointer image on the basis of the position information transmitted from the projector 101, and the generated pointer image is superimposed on the image that is being projected.

In such a case, the projection screen 102, for example, displays the pointer image formed by the laser pointer 108 and the pointer image generated on the basis of the position information obtained from the projector 101a. Therefore, the image obtained by capturing the image on the projection screen includes the pointer image 109 formed by the laser pointer 108 and the pointer image generated on the basis of the position information obtained from the projector 101a.

The projector 101 has the information regarding the display position of the pointer image generated on the basis of the position information obtained from the projector 101a.

Therefore, in the case where two pointer images are included in the image obtained by capturing the image on the projection screen, the pointer image formed by the laser pointer 108 is distinguished from the pointer image formed on the basis of the position information received from the projector 101a using the position information received from the projector 101a. Then, the position of the pointer image 109 formed by the laser pointer 108 is detected and the position information thereof is transmitted.

Thus, referring to FIG. 18, the same image data is stored in the storages of the projectors 101 and 101a and is projected by the projectors 101 and 101a. Therefore, the users 107 and 107a can participate in a meeting while viewing the same image.

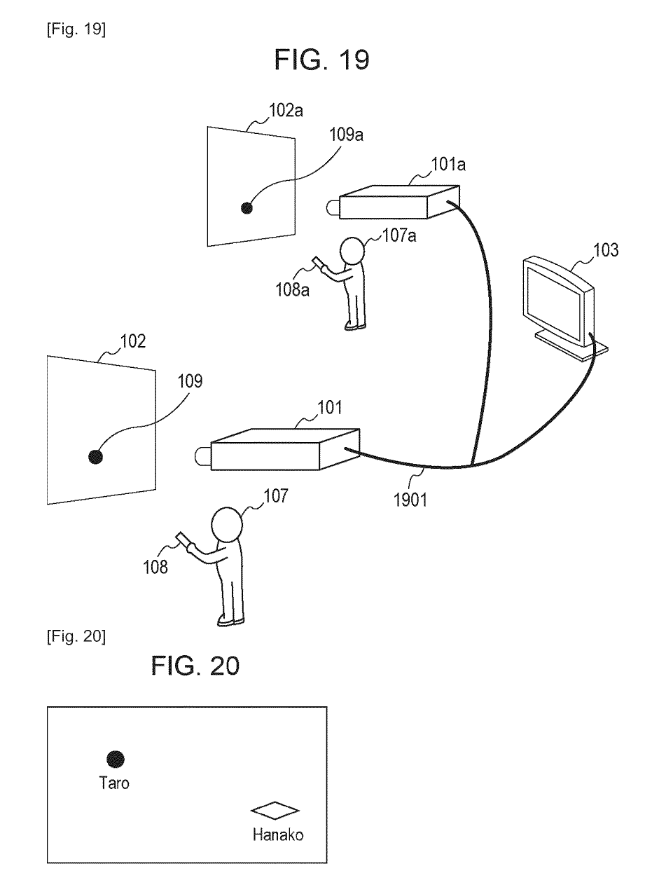

Alternatively, as shown in FIG. 19, two projectors 101 and 101a may be connected to the display apparatus 103 via a network 1901.

In this case, the position information of the pointer image is transmitted to the display apparatus 103 from each of the projectors 101 and 101a.

As shown in FIG. 20, the display apparatus displays the pointer images together with the information indicating the transmission sources of the position information. Therefore, a user who views the display apparatus 103 can easily distinguish the pointer images of the projectors 101 and 101a from each other.

According to the above-described embodiments, the projector is connected to the external display apparatus or to another projector with the Ethernet (registered trademark). However, the present invention is not limited to this, and other types of transmission lines can also be used. For example, USB, UDMI, etc., can also be used as long as control commands can be transmitted.

1. A projection apparatus comprising:
a projection unit configured to project an image onto a projection screen;
an image pickup unit configured to capture an image on the projection screen;
a detection unit configured to detect, using image signals obtained by the image pickup unit, a plurality of pointer images each indicating a position on the projection screen and generate position information regarding the positions indicated by the plurality of pointer images displayed on the projection screen and information indicating a quantity of the pointer images displayed on the projection screen expressed as a number; and
an output unit configured to output the position information and the information indicating the number of pointer images.

2. (canceled)

3. The projection apparatus according to claim 1, further comprising:
a control unit configured to control whether to cause the output unit to output the position information for each pointer image.

4. (canceled)

5. The projection apparatus according to claim 1, wherein the detection unit generates identification information for identifying the plurality of pointer images, and the output unit outputs the identification information together with the position information for each pointer image.

6. (canceled)

7. The projection apparatus according to claim 1, further comprising:
a storage unit configured to store a piece of image data,
wherein the projection unit projects the image based on the piece of image data, and
wherein the position information generated by the detection unit indicates a relative position of the pointer image with respect to the piece of image data.

8. (canceled)

9. The projection apparatus according to claim 1, wherein the output unit generates transmission source information for identifying the projection apparatus, and outputs the transmission source information together with the position information.

10-15. (canceled)

16. A display system comprising:
a projection apparatus including:
a projection unit configured to project an image onto a projection screen,
an image pickup unit configured to capture an image on the projection screen,
a detection unit configured to detect, by using image signals obtained by the image pickup unit, a plurality of pointer images each indicating a position on the projection screen and generate position information regarding the positions indicated by the plurality of pointer images displayed on the projection screen and information indicating a quantity of the pointer images displayed on the projection screen expressed as a number, and
an output unit configured to output the position information and the information indicating the number of pointer images; and
a display apparatus including:
an input unit configured to input the position information and the information indicating the number of pointer images output from the projection apparatus,
a generating unit configured to generate a plurality of pieces of predetermined image data each indicating a part of a display screen, based on the position information and the information indicating the number of pointer images input by the input unit, and
a display unit configured to display on the display screen an image obtained by combining the plurality of pieces of predetermined image data generated by the generating unit and a piece of display image data.

17. A projection apparatus comprising:
a projection unit configured to project an image onto a projection screen;
an image pickup unit configured to capture an image on the projection screen;
a detection unit configured to detect a pointer image indicating a position on the projection screen using an image signal obtained by the image pickup unit and generate position information regarding the position indicated by the pointer image displayed on the projection screen;
an output unit configured to transmit the position information to an external display apparatus;
a setting unit configured to set a pointer display mode for transmitting the position information to the external display apparatus in accordance with an instruction by a user; and
a control unit configured to control the output unit to transmit the position information to the external display apparatus if the pointer display mode is set by the setting unit, and to stop transmitting the position information to the external display apparatus if the pointer display mode is not set by the setting unit.

18. The projection apparatus according to claim 17, wherein the detection unit detects, by using image signals obtained by the image pickup unit, a plurality of pointer images each indicating a position on the projection screen and generates position information regarding the positions indicated by the plurality of pointer images displayed on the projection screen, and the output unit transmits the position information regarding the positions indicated by the plurality of pointer images to the external display apparatus.

19. The projection apparatus according to claim 18, wherein the control unit determines whether to cause the output unit to transmit the position information for each pointer image in accordance with an instruction by the user.

20. The projection apparatus according to claim 18, wherein the detection unit generates identification information for identifying the plurality of pointer images, and the output unit transmits the identification information together with the position information for each pointer image.

21. The projection apparatus according to claim 17, wherein the control unit controls the detection unit to detect the pointer image if the pointer display mode is set by the setting unit, and to stop detecting the pointer image if the pointer display mode is not set by the setting unit.

22. The projection apparatus according to claim 17, further comprising:
a storage unit configured to store a piece of image data,
wherein the projection unit projects the image based on the piece of image data, and the output unit transmit image data stored in the storage unit to the external display apparatus in the pointer display mode.
